(19) United States
(12) Patent Application Publication
(10) Pub. No.: US 2015/0261537 A1
(43) Pub. Date: Sep. 17, 2015

(54) METHOD OF DECODING INSTRUCTIONS IN MICROPROCESSOR

(71) Applicant: Advanced Digital Chips Inc., Gyeonggi-do (KR)

(72) Inventors: Young Ho CHA, Gyeonggi-do (KR); Kwang Ho LEE, Seoul (KR); Chang Seon JO, Gyeonggi-do (KR); Kwan Young KIM, Gyeonggi-do (KR); Byung Gueon MIN, Gyeonggi-do (KR)

(73) Assignee: Advanced Digital Chips Inc., Gyeonggi-do (KR)

(21) Appl. No.: 14/259,763

(22) Filed: Apr. 23, 2014

(30) Foreign Application Priority Data
Mar. 13, 2014 (KR) 10-2014-0029591

(51) Int. Cl. G06F 9/30

(52) U.S. Cl. CPC G06F 9/30145; G06F 9/30032; G06F 9/3001

(57) ABSTRACT

Provided is a method of decoding instructions in a microprocessor, including: checking existence of instructions when instruction decoding is stared; folding two instructions when two instructions exist; and decoding folded instructions. Accordingly, it is possible to improve performance in a microprocessor by generating one instruction by folding two instructions into one instruction in an instruction decoding period.

### CROSS REFERENCES TO RELATED APPLICATIONS

This application claims priority to Korean Patent Application No. 10-2014-0029591, filed in the Korean Patent Office on Mar. 13, 2014, the entire contents of which are incorporated herein by reference.

### FIELD

The present invention relates to a method of decoding instructions in a microprocessor.

### BACKGROUND

As components constituting a general-purpose microprocessor, there are instruction sets, registers, memory spaces, and the like. The instruction sets are mainly classified into RISCs (reduced instruction set computers) and CISCs (complex instruction set computers).

The CISC is a computer which is designed to be configured with maximum possible hardware in order to facilitate software execution, particularly, compiler creation. On the contrary, the RISC is a computer which is designed to be configured so that complicated processes are executed by software if possible in order to increase an execution rate.

The characteristics of the RISC are described in comparison with the characteristics of CISC as follows. Firstly, most of the instructions are executed in one machine cycle; an instruction length is fixed; and an instruction set is configured in a simple structure. For example, an access to a memory is limited to Load/Store instructions.

Secondly, the number of addressing modes is small; the number of control processes by micro-programs is reduced; and a lot of wired logics are used. However, the number of registers is large; and the registers are disposed in a chip space where the micro-programs are stored.

Thirdly, since assembler codes are hard to read and there is a portion where some assembler codes may not be arrayed in a time sequence in order to effectively use pipelines, the compiler needs to be optimized. If there is no optimization, the pipelines cannot be effectively used, and the RISC becomes useless.

An instruction set architecture (ISA) is an architecture of machine code instructions which are recognized by a microprocessor to understand and execute functions. Different microprocessors have different machine code length and number codes, and bits of an instruction are divided according to functions to allocate meanings and are digitized. Since it is inconvenient for program developers to create programs by using numbers, assembly language codes are used which are configured with characters corresponding to machine codes.

The ISA is a lowermost-level programming interface and is configured to include all kinds of instructions which can be executed by a processor. An instruction set, that is, an instruction set architecture is a portion of a programming computer architecture including data type, instruction, register, addressing mode, memory structure, interrupt, exception process, and external input/output. The ISA includes an opcode set standard (machine code) including pure instructions added to a specific CPU architecture.

In an RISC CPU, an instruction structure and instruction numbers are simplified, so that an execution rate can be increased and hardware can be reduced.

In an ARM CPU, an execution rate can be increased and power consumption can be reduced through its simplification, so that the ARM CPUs are actively used for mobile devices such as mobile phones. The length of an instruction in the ARM architecture is 32 bit (except for 16-bit Thumb), and an operand exists in 32 bits. This structure is compared with a CISC structure where an operand follows an opcode. In the ARM architecture, since all the 32 bits cannot be allocated, it is impossible to allocate long-distance addresses and data, so that there may be a need to use multiple instructions.

An MIPS (Microprocessor without Interlocked Pipeline Stages) is an RISC microprocessor developed by MIPS Technology.

The MIPS architecture has been used for computer systems of Silicon Graphics, many embedded systems and Window CE systems, routers of Cisco Systems. Besides, the MIPS architecture has also been used for Playstation, Playstation II, Playstation Portable of Sony, or other game consoles. On the other hand, in Korea, the MIPS architecture has been used for (station T43 produced by Istation.

At the beginning, the MIPS processors were configured as a 32-bit architecture. The MIPS processors were configured to include 32-bit registers and data paths. After that, the MIPS processors have been configured as a 64-bit architecture. There are five types of lower-level compatible MIPS operation sets, which are called MIPS I, MIPS II, MIPS III, MIPS IV, and MIPS 32/64. In MIPS 32/64 release 2, besides the operation sets, control register sets are also defined. In addition, an SIMD extended function for 3-D graphic, for example, MIPS-3D also exists. An MDMX (MaDMaX) extension is an integer operation set using 64-bit floating point registers. At recent, a multithreading function such as a hyperthreading function MIPS MT of an Intel Pentium 4 processor has been added. The MIPS processor had great influence on next-generation RISC architectures.

Recently, code compression techniques have been actively used in the field of microprocessors. The code compression techniques have many advantages of reduction in cost for instruction storage in embedded systems.

Therefore, code compression methods capable of reducing the number of fields of opcode, the number of registers, the number of operands, and the number of immediate values have been used.

However, the code compression methods have problems in that the number of instructions is increased and the performance of a microprocessor is lowered. For example, since a portion processed by one instruction in a 32-bit ISA is compressed through a 16-bit ISA to be divided into two instructions for the processing, the performance of a microprocessor is deteriorated.

Korean Patent Application Laid-Open No. 10-2014-0011940 is disclosed in the related art.

### SUMMARY

The present invention is to provide a method of decoding instructions capable of improving performance in a microprocessor by generating one instruction by folding two instructions into one instruction in an instruction decoding period.

The present invention is not limited to the aforementioned object, but other objects that are not mentioned are to be understood by the ordinarily skilled in the related art.

According to an aspect of the present invention, there is provided a method of decoding instructions in a microprocessor, including: checking existence of instructions when instruction decoding is stared; folding two instructions when two instructions exist; and decoding folded instructions.

In the above aspect, the microprocessor may be an RISC (Reduced Instruction Set Computer) processor, and in the RISC processor, a 32-bit ISA (Instruction Set Architecture) may be compressed into a 16-bit ISA, and the compressed instruction architecture is decoded.

In addition, in the above aspect, the method may further include: checking existence of an arithmetic operation instruction or a MOVE instruction when the instruction decoding is started; checking whether or not the next instruction is a MOVE instruction when the arithmetic operation instruction exists in the checking of existence of an arithmetic operation instruction or a MOVE instruction; folding the arithmetic operation instruction and the MOVE instruction when the next instruction is a MOVE instruction in the checking whether or not the next instruction is a MOVE instruction; checking when the MOVE instruction exists in the checking of existence of an arithmetic operation instruction or a MOVE instruction; folding the arithmetic operation instruction and the MOVE instruction when the next instruction is an arithmetic operation instruction in the checking whether or not the next instruction is an arithmetic operation instruction; and decoding the instruction folded in the folding of the arithmetic operation instruction and the MOVE instruction when the next instruction is a MOVE instruction or in the folding of the arithmetic operation instruction and the MOVE instruction when the next instruction is an arithmetic operation instruction into a 3-address instruction.

In addition, in the above aspect, the method may further include: checking existence of an extension instruction which is an instruction of extending an immediate value when the instruction decoding is started; checking whether the next instruction is an instruction of processing a data value for processing long immediate data or an instruction of processing an address value for processing a long address when the extension instruction exists in the checking of existence of an extension instruction; folding the extension instruction and the data value when the next instruction is an instruction of processing a data value in the checking whether the next instruction is an instruction of processing a data value for processing long immediate data or an instruction of processing an address value for processing a long address; folding the extension instruction and the address value when the next instruction is an instruction of processing an address value in the checking whether the next instruction is an instruction of processing a data value for processing long immediate data or an instruction of processing an address value for processing a long address; and decoding the instruction folded in the folding of the extension instruction and the data value or in the folding of the extension instruction and the address value.

According to the present invention, it is possible to improve performance in a microprocessor by generating one instruction by folding two instructions into one instruction in an instruction decoding period.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating an MIPS16 code compression scheme;

FIG. 2 is a diagram illustrating 2-address instructions and a 3-address instruction; and

FIG. 3 is a flowchart illustrating a method of decoding instructions in a microprocessor according to an embodiment of the present invention.

### DETAILED DESCRIPTION

Since various modifications are available and various embodiments are exemplified, the present invention will be described in detail by particular embodiments with reference to the drawings. However, it should be noted that the present invention is not limited to the embodiments, but it includes all the modifications, equivalents, and substitutes.

Terms used in the specification are intended to explain particular embodiments but not intended to limit the present invention. If not expressed in a definite manner, an element expressed with a singular term is intended to include a plurality of the elements. In the specification, terms “to comprise”, “to include”, and “to have” and the like should be understood that they are intended to represent the existence of features, numbers, steps, operations, components, parts, or a combination thereof but not intended to exclude the existence of or a possibility of addition of features, numbers, steps, operations, components, parts, or a combination thereof in advance. If not defined as different meanings, all the terms including technical or scientific terms have the same meanings as they are generally understood by the ordinarily skilled in the related art. The terms defined in generally-used dictionaries should be understood to have the same meanings as they have in context of related technologies. If not explicitly defined in the specification, the terms should not be understood in view of ideal meanings or strictly literal meanings.

In addition, in the description of the drawings, the same components are denoted by the same reference numerals, and the redundant description thereof will be omitted. If the present invention may be unclear by describing a well-known technique, the detailed description thereof will be omitted.

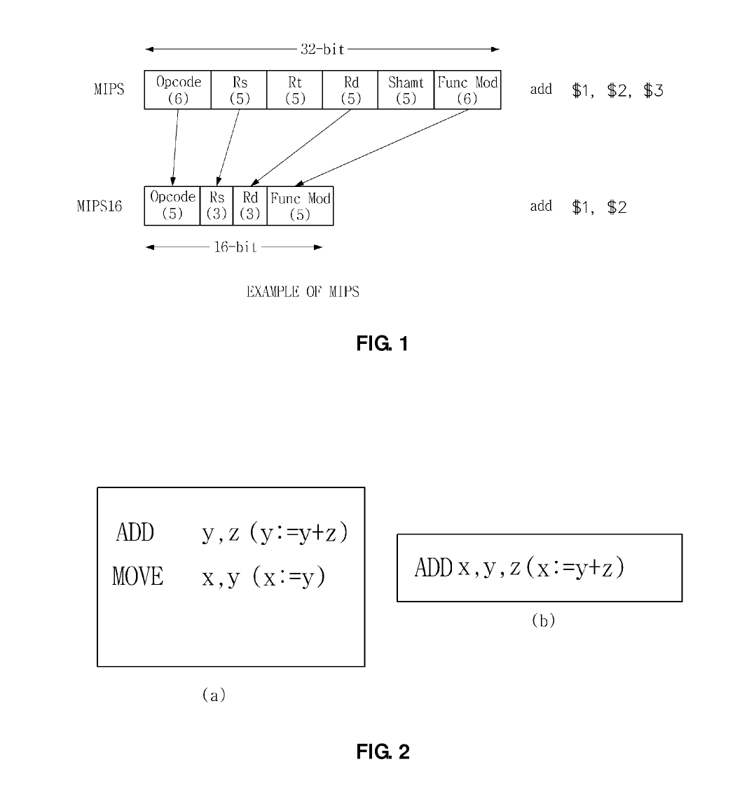

FIG. 1 is a diagram illustrating an MIPS16 code compression scheme.

FIG. 1 illustrates a process of compressing a 32-bit ISA (Instruction Set Architecture) into a 16-bit ISA by using an MIPS16 code compression scheme in an MIPS (Microprocessor without Interlocked Pipeline Stages).

In order to compress a 32-bit ISA into a 16-bit ISA, the followings are performed.

(1) To reduce the field of Opcode,

(2) To reduce the number of registered used for an operation,

(3) To reduce the number of operands (N-address instructions) used for an operation,

(4) To reduce immediate values for processing data and addresses.

As a result of the compression, a portion which is processed by a single instruction in the 32-bit ISA may be divided into portions which are to be processed by two or more instructions. Therefore, the performance of the microprocessor is deteriorated.

FIG. 2 is a diagram illustrating 2-address instructions and a 3-address instruction.

In FIG. 2, (a) illustrates 2-address instructions, and (b) illustrates a 3-address instruction.

Referring to FIG. 2, in the 16-bit ISA, since an instruction is compressed by 16 bits, a 3-address instruction which is to be processed by three addresses is divided into 2-address instructions or 1-address instructions.

For example, an operation x=y+z can be processed by one 3-address instruction. However, in the 16-bit ISA, the 3-address instruction is divided into 2-address instructions, that is, an ADD instruction and a MOVE instruction. In this case, according to a compile method or a variable transfer method, the ADD instruction may be a preceding instruction, or the MOVE instruction may be a preceding instruction.

In other words, at the time of processing the operation x=y+z, in the 16-bit ISA, a structure of ADD+MOVE or a structure of MOVE+ADD are not allowed.

If the ADD instruction (an arithmetic operation instruction) and the MOVE instruction are processed in the instruction fetching order of the microprocessor, the performance is lowered to be half of the performance of the processes using the 3-address structure.

In order to prevent the deterioration in performance, according to the present invention, in an instruction decoding period, an ADD instruction and a MOVE instruction are folded to generate one instruction (3-address instruction), so that the performance of the microprocessor is improved.

In a 16-bit ISA architecture, an immediate value having a short length is generated as one instruction.

However, in the 16-bit ISA architecture, there is no method of processing an immediate value of 16 bits or more by using one instruction.

There are a case of adding an instruction for extending data bits in order to process such a long immediate value and a case of adding an instruction for extending address bits in order to process a long address. In these cases, since the extension instruction is added, the long immediate value is processed by two or more instructions.

Due to the addition of the extension instruction, the performance of a processor with a 16-bit ISA architecture is lowered down to ½ or less.

Therefore, in the instruction decoding period, if one instruction (long immediate instruction) is generated by folding the instruction for extending the immediate value and instruction for processing the immediate value, the performance of the microprocessor is improved.

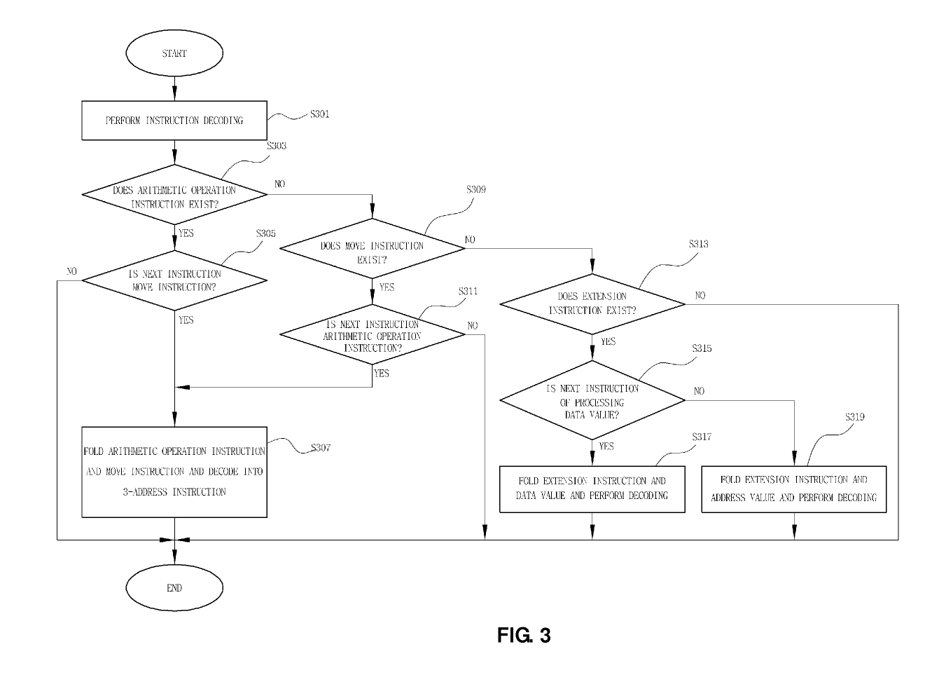

FIG. 3 is a flowchart illustrating a method of decoding instructions in a microprocessor according to an embodiment of the present invention.

Referring to FIG. 3, when instruction decoding is started, it is checked whether or not an arithmetic operation instruction exists (S303).

When the arithmetic operation instruction exists in Step S303, it is checked whether or not the next instruction is a MOVE instruction (S305).

When the next instruction is a MOVE instruction in Step S305, decoding is performed by folding the arithmetic operation instruction and the MOVE instruction into a 3-address instruction (S307).

When the arithmetic operation instruction does not exist in Step S303, it is checked whether or not a MOVE instruction exists (S309).

When the MOVE instruction exists in Step S309, it is checked whether or not the next instruction is an arithmetic operation instruction (S311).

When the next instruction is an arithmetic operation instruction in Step S311, decoding is performed by folding the arithmetic operation instruction and the MOVE instruction into a 3-address instruction (S307).

When a MOVE instruction does not exist in Step S309, it is checked whether or not an extension instruction which is an instruction for extending an immediate value exists (S313).

When an extension instruction exists in Step S313, it is checked whether or not the next instruction is an instruction of processing a data value for processing long immediate data (S315).

When the next instruction is an instruction of processing a data value in Step S315, decoding is performed by folding the extension instruction and the data value (S317).

When the next instruction is an instruction of processing an address value for processing a long address not an instruction of processing a data value in Step S315, decoding is performed by folding the extension instruction and the address value (S319).

While the present invention has been particularly shown and described with reference to exemplary embodiments thereof, it will be understood by those skilled in the art that the present invention is not limited to the exemplary embodiments and various changes in form and details may be made therein without departing from the spirit and scope of the invention as defined by the appended claims.

What is claimed is:

1. A method of decoding instructions in a microprocessor, comprising:
checking existence of instructions when instruction decoding is stared;
folding two instructions when two instructions exist; and
decoding folded instructions.

2. The method according to claim 1,
wherein the microprocessor is an RISC (Reduced Instruction Set Computer) processor, and
wherein in the RISC processor, a 32-bit ISA (Instruction Set Architecture) is compressed into a 16-bit ISA, and the compressed instruction architecture is decoded.

3. The method according to claim 2, further comprising:
checking existence of an arithmetic operation instruction or a MOVE instruction when the instruction decoding is started;
checking whether or not the next instruction is a MOVE instruction when the arithmetic operation instruction exists in the checking of existence of an arithmetic operation instruction or a MOVE instruction;
folding the arithmetic operation instruction and the MOVE instruction when the next instruction is a MOVE instruction in the checking whether or not the next instruction is a MOVE instruction;
checking when the MOVE instruction exists in the checking of existence of an arithmetic operation instruction or a MOVE instruction;
folding the arithmetic operation instruction and the MOVE instruction when the next instruction is an arithmetic operation instruction in the checking whether or not the next instruction is an arithmetic operation instruction; and
decoding the instruction folded in the folding of the arithmetic operation instruction and the MOVE instruction when the next instruction is a MOVE instruction or in the folding of the arithmetic operation instruction and the MOVE instruction when the next instruction is an arithmetic operation instruction into a 3-address instruction.

4. The method according to claim 2, further comprising:
checking existence of an extension instruction which is an instruction of extending an immediate value when the instruction decoding is started;
checking whether the next instruction is an instruction of processing a data value for processing long immediate data or an instruction of processing an address value for processing a long address when the extension instruction exists in the checking of existence of an extension instruction;
folding the extension instruction and the data value when the next instruction is an instruction of processing a data value in the checking whether the next instruction is an instruction of processing a data value for processing long immediate data or an instruction of processing an address value for processing a long address;
folding the extension instruction and the address value when the next instruction is an instruction of processing an address value in the checking whether the next instruction is an instruction of processing a data value for processing long immediate data or an instruction of processing an address value for processing a long address; and
decoding the instruction folded in the folding of the extension instruction and the data value or in the folding of the extension instruction and the address value.
